(19) United States
(12) Patent Application Publication
(10) Pub. No.: US 2026/0056444 A1
(43) Pub. Date: Feb. 26, 2026

(54) VARIABLE APERTURE DEVICE FOR CAMERA MODULE AND PRODUCT INCLUDING THE SAME

(71) Applicant: HUAWEI TECHNOLOGIES CO., LTD., Shenzhen (CN)

(72) Inventors: Kazuhiro Hattori, Tokyo (JP); Kazuki Sakae, Tokyo (JP); Fuwei Zhang, Dongguan (CN)

(73) Assignee: HUAWEI TECHNOLOGIES CO., LTD., Shenzhen (CN)

(21) Appl. No.: 19/104,189

(22) PCT Filed: Aug. 15, 2022
(86) PCT No.: PCT/CN2022/112571

§ 371 Date: Feb. 14, 2025

(51) Int. Cl. G03B 9/06

(52) U.S. Cl. CPC G03B 9/06

(57) ABSTRACT

The present invention relates to a variable aperture device for a camera module. The device comprises: a base having a base aperture and a pair of blade guides; a pair of main blades guided by the blade guides; a pair of supplemental blades guided by the blade guides; a cover that is fixed to the base and has a cover aperture; and an actuator for moving the main blades and the supplemental blades relative to the base. Each of the main blades has a respective notch. The notches collaboratively define a central aperture and a fixed aperture. Each of the supplemental blades has a respective notch. The notches collaboratively define a minimum aperture and a maximum aperture.

### CROSS-REFERENCE TO RELATED APPLICATIONS

This application is a National Stage of International Application No. PCT/CN2022/112571, filed on Aug. 15, 2022, which is hereby incorporated by reference in its entirety.

### TECHNICAL FIELD

The present disclosure relates to a variable aperture device to be used in a camera module or a camera unit of various products, in particular, various mobile electronic devices including smartphones, mobile phones, etc. The present disclosure also relates to a product including such a variable aperture device.

### BACKGROUND ART

In recent years, in a camera module that is implemented in a mobile device such as a smartphone, a variable aperture device is focused in order to realize higher picture quality. In addition to this, some smartphones have started to adopt “a macro shooting function”.

In a macro shooting, the variable aperture devices contribute to a higher optical performance and obtaining a bigger depth of field.

With regard to camera specifications, a requirement for a big aperture (bright Fno.) has been increased, and along with this, a variable aperture also requires having a big aperture diameter.

However, a variable aperture with a big diameter causes an enlargement of the variable aperture device itself, and thus leads to an enlargement of the camera module.

As a structure of a variable aperture device suitable for the requirement of miniaturization, a structure in which two blades are driven by one actuator is proposed, for example, as disclosed in JP2017167186A. In this structure, the variable aperture is implemented by controlling the opening and the closing of two blades. Also, in this structure, an arm is mechanically connected to a drive unit, and the two blades can be driven at the same time by the movement (in particular, revolution) of the arm. Therefore, space for an actuator for opening and closing the two blades can be saved, and thus the size of the variable aperture device (in particular, a width thereof) can be reduced.

On the other hand, in JP2021056448A, a structure using a shape memory alloy element (hereinafter, referred to as “SMA element”) as an actuator which drives blades is proposed. In general, the SMA element is known as being a small actuator. In JP2021056448A, the SMA element is located overlapping with a blade in the thickness direction thereof, because the actuator size is sufficiently small. Therefore, the size of the variable aperture device can be reduced.

In general, the variable aperture device has a fixed aperture which determines a light amount passing through the variable aperture device in an “open state”. Furthermore, in a “closed state” of the variable aperture device, in order to get a predetermined light amount, a central aperture is formed by driving the blades. In this state, from an optical point of view, the central aperture should be located at the center of the fixed aperture.

In the structure presented in JP2017167186A, a blade back size of the blade needs to be large enough so as not to reveal a hole except for a center hole in the closed state. Therefore, a space to store the blades in the open state needs to be large, and as a result, this causes an unfavorable enlargement of the variable aperture device.

On the other hand, in the structure presented in JP2021056448A, as stated above, a small SMA element is used as the actuator. However, it is difficult to get a large stroke due to the characteristics of the SMA element. This means that a movable stroke of the blade is limited to a large extent. Due to this problem, it is difficult for the SMA element to be applied to a variable aperture device with a big aperture diameter in which a long blade stroke is required. In addition to this, the solution described in JP2021056448A cannot solve the problem of the enlargement of the variable aperture device due to the blade back size of the blades, as well as the solution described in JP2017167186A.

In summary, the problem in relation to the structure disclosed in JP2017167186A is that the blade back size of the blades needs to be large enough, which causes the unfavorable enlargement of the variable aperture device. The problem in relation to the structure disclosed in JP2021056448A is not only that the blade back size of the blade needs to be large enough, which causes the unfavorable enlargement of the variable aperture device, but also that the blade stroke is limited to a large extent.

For these reasons, there is a demand for a variable aperture device for a camera module, which is smaller than prior art devices and has a level of reliability equal to or higher than larger prior art devices.

### SUMMARY

In view of the above, an object of the present disclosure is to provide a novel variable aperture device for a camera module, which can overcome or at least alleviate the problems stated above in relation to the prior art devices. In particular, a more specific object of the present disclosure is to provide a novel variable aperture device for a camera module that is smaller than prior art devices and has a level of reliability equal to or higher than larges prior art devices.

In order to achieve these objects, the present disclosure provides a variable aperture device for a camera module, comprising: (i) a base having a base aperture and a pair of blade guides, wherein the pair of blade guides are provided on opposite longitudinal edges of the base with the base aperture in between; (ii) a pair of main blades guided by the pair of blade guides of the base, wherein the pair of main blades are slidably arranged relative to the base so as to be close to and separated from each other, wherein each of the main blades has respective notch, and wherein the notches collaboratively define a central aperture when the pair of main blades are closest to each other and collaboratively define a fixed aperture when the pair of main blades are farthest from each other; (iii) a pair of supplemental blades guided by the pair of blade guides of the base, wherein the pair of supplemental blades are slidably arranged relative to the base so as to be close to and separated from each other, wherein each of the supplemental blades has respective notch, and wherein the notches collaboratively define a minimum aperture surrounding the central aperture when the pair of supplemental blades are closest to each other and collaboratively define a maximum aperture substantially corresponding to the fixed aperture when the pair of supplemental blades are farthest from each other; (iv) a cover that is fixed to the base and has a cover aperture substantially corresponding to the fixed aperture, wherein the cover is configured to restrain the pair of main blades and the pair of supplemental blades in a space between the base and the cover; and (v) an actuator for moving the pair of main blades and the pair of supplemental blades relative to the base. The variable aperture device according to the present disclosure is characterized in that each of the supplemental blades is configured to project outward from lateral edges of the main blades perpendicular to the longitudinal edges of the base when the pair of main blades are closest to each other and the pair of supplemental blades are closest to each other.

The present disclosure also provides a product including a camera module, wherein the camera module comprises a variable aperture device as stated above.

According to the present disclosure, the pair of supplemental blades are further added to the variable aperture device. These supplemental blades are configured to project outward from the lateral (i.e., vertical) edges of the main blades when the pair of main blades are closest to each other and the pair of supplemental blades are closest to each other. Therefore, a problem that arises when the size of the main blades are shortened in a sliding movement direction thereof (i.e., in a longitudinal or horizontal direction), that is, the generation of unwanted holes that allow light to pass, around the central aperture of the variable aperture device, can be avoided. This is because the supplemental blades can cover such unwanted holes in a projected state. In other words, according to the present disclosure, by shortening the longitudinal (horizontal) length of the blade back of the main blade, the variable aperture device can be made smaller, especially in a longitudinal or horizontal direction, compared to any conventional devices, without the occurrence of the unwanted holes. This is because the shortening of the longitudinal length of the blade back of the main blade effectively saves a space in the device for storing the main blade in the open state.

According to one embodiment of the present disclosure, the pair of supplemental blades are interposed between the base and the pair of main blades. However, in another aspect of the present disclosure, the pair of supplemental blades may be interposed between the cover and the pair of main blades.

According to one embodiment of the present disclosure, the actuator includes a pair of rotatable arms with a boss provided at the tip of the arms, wherein the pair of main blades have respective cam grooves and the pair of supplemental blades have respective cam groove, wherein the boss of the rotatable arms is configured to be accommodated within the cam grooves of the main blades and the cam grooves of the supplemental blades, and wherein a rotation of the rotatable arms is converted by the cam grooves of the main blades and the cam grooves of the supplemental blades into a linear movement of the main blades and the supplemental blades. In this embodiment of the present disclosure, the pair of rotatable arms may be rotatably supported by the base. This embodiment achieves a particularly simple and reliable structure. Furthermore, in this embodiment of the present disclosure, the cover may have a pair of cam grooves, and the boss of the rotatable arms may be configured to be able to enter into the cam grooves of the cover.

According to one embodiment of the present disclosure, when the pair of supplemental blades has moved to a closed position where the minimum aperture is collaboratively defined by the notches of the pair of supplemental blades, the cam grooves of the supplemental blades are covered by the pair of main blades and the cam grooves of the main blades are covered by the pair of supplemental blades.

According to one embodiment of the present disclosure, when the pair of supplemental blades has moved to a closed position where the minimum aperture is collaboratively defined by the notches of the pair of supplemental blades, the pair of rotatable arms are in a position approximately parallel to the direction of movement of the pair of supplemental blades. In this embodiment of the present disclosure, when the pair of rotatable arms are in a position approximately parallel to the direction of movement of the pair of supplemental blades, the pair of rotatable arms may be hidden behind the pair of supplemental blades. This embodiment achieves a particularly compact structure of the device.

According to one embodiment of the present disclosure, when the pair of main blades and the pair of supplemental blades move linearly, the first arm and the second arm of the pair of rotatable arms rotate in an opposite direction to each other. This embodiment also contributes to the realization of a compact structure of the device.

According to one embodiment of the present disclosure, the variable aperture device further comprises a pair of secondary supplemental blades guided by the pair of blade guides of the base, wherein the pair of secondary supplemental blades are slidably arranged relative to the base so as to be close to and separated from each other, wherein each of the secondary supplemental blades has respective notch, wherein the notches collaboratively define a minimum aperture surrounding the central aperture when the pair of secondary supplemental blades are closest to each other and collaboratively define a maximum aperture surrounding or substantially corresponding to the fixed aperture when the pair of secondary supplemental blades are farthest from each other, and wherein each of the secondary supplemental blades is configured to project outward from lateral (vertical) edges of the main blades perpendicular to the longitudinal edges of the base when the pair of main blades are closest to each other, the pair of supplemental blades are closest to each other, and the pair of secondary supplemental blades are closest to each other. According to this embodiment, the area of the part of the main blades opposite to the side on which the notches are formed (i.e., “blade back”) can be further reduced. This contributes to further compactification of the device.

According to one embodiment of the present disclosure, the pair of secondary supplemental blades have respective cam grooves, wherein the boss of the rotatable arms is configured to be further accommodated within the cam grooves of the secondary supplemental blades, and wherein the rotation of the arm is converted by the cam grooves of the secondary supplemental blades into a linear movement of the secondary supplemental blades. This embodiment also achieves a particularly compact structure.

According to one embodiment of the present disclosure, the pair of secondary supplemental blades are interposed between the base and the pair of supplemental blades. However, in another aspect of the present disclosure, the pair of secondary supplemental blades may be interposed between the cover and the pair of main blades or between the pair of main blades and the pair of supplemental blades.

According to one embodiment of the present disclosure, the central aperture collaboratively defined by the notches of the main blades is circular. Furthermore, in one embodiment of the present disclosure, the base aperture, the fixed aperture collaboratively defined by the notches of the main blades, the minimum and maximum apertures collaboratively defined by the notches of the supplemental blades, and the cover aperture may be non-circular, for example, they may be approximately oval. However, these apertures may be set to any shape and dimensions as needed, as long as they do not interfere with the central aperture.

With regard to the product including a camera module, according to one embodiment of the present disclosure, the product may be a device, an apparatus, an equipment, a machine, a facility, a tool, or the like, which includes the camera module. In particular, the product may be a mobile electronic device including the camera module.

### BRIEF DESCRIPTION OF THE DRAWINGS

Non-limiting and representative embodiments of the present disclosure will now be explained in detail below, referring to the attached drawings.

FIG. 1 is a schematic view of a product, i.e., a smartphone that incorporates a camera module including a variable aperture device according to one embodiment of the present disclosure.

FIG. 2 is a perspective view of the variable aperture device of the camera module shown in FIG. 1, wherein the variable aperture device is an open state.

FIG. 3 is a front view of the variable aperture device shown in FIG. 2, wherein the variable aperture device is the open state.

FIG. 4 is a front view of the variable aperture device shown in FIG. 2, wherein the variable aperture device is a closed state.

FIG. 5 is an exploded perspective view of the variable aperture device shown in FIGS. 2 to 4.

FIG. 6 schematically shows a fixed aperture and a central aperture formed in a conventional variable aperture device, wherein the cover of the device is removed for clarity.

FIG. 7 schematically shows a fixed aperture and a central aperture formed in the variable aperture device shown in FIGS. 2 to 5, wherein the cover of the device is removed for clarity.

FIG. 8 schematically shows a relationship between an arm stroke and a blade stroke in the conventional variable aperture device, wherein the cover of the device is removed for clarity.

FIG. 9 schematically shows a relationship between an arm stroke and a blade stroke in the variable aperture device shown in FIGS. 2 to 5, wherein the cover of the device is removed for clarity.

FIG. 10 schematically shows the variable aperture device shown in FIGS. 2 to 5 in the open state and the closed state, seen from the back side (i.e., from a lens side of the camera module).

FIG. 11 schematically shows the positional relationship of each blade in the closed state in the variable aperture device shown in FIGS. 2 to 5, seen from the front side.

FIG. 12 schematically shows the positional relationship of each blade in the closed state in a comparative example where the shape of the cam grooves is not appropriate, seen from the front side.

FIG. 13 is an exploded perspective view of the variable aperture device according to another embodiment of the present disclosure.

FIG. 14 is a plan view which shows the modified shape of the main blade of the variable aperture device shown in FIG. 13.

FIG. 15 is a front view of a reference example for explaining the effect brought about by the variable aperture device shown in FIG. 13.

### DETAILED DESCRIPTION OF EMBODIMENTS

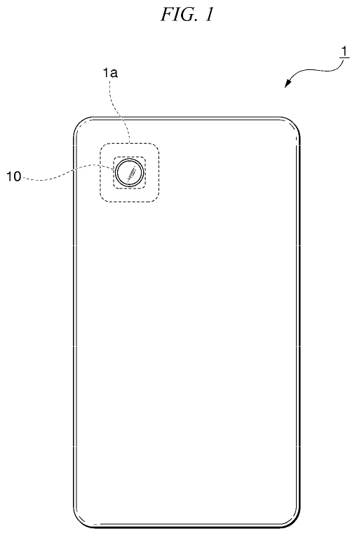

Some exemplary embodiments of the present disclosure will now be described with reference to FIGS. 1 to 15.

As used herein, terms related to the direction such as “front”, “back”, “side”, “top”, “bottom”, “up”, “down”, “upper”, “lower”, “upward”, “downward”, “right”, “left”, “longitudinal”, “lateral”, “horizontal”, “vertical” etc. are to be understood in relation to the orientation of the device in the figures, which may or may not match the actual orientation in use.

The following exemplary embodiments of the present disclosure relate to a variable aperture device to be used in a camera module of, but not limited thereto, products such as a mobile electronic device, in particular a smartphone. Furthermore, the following exemplary embodiments of the present disclosure also relate to such products, in particular a mobile electronic device, including a camera module which comprises the variable aperture device, being one exemplary embodiment of the present disclosure. However, the product can be any device, any apparatus, any equipment, any machine, any facility, any tool, or the like, which includes a camera module.

FIG. 1 shows a mobile electronic device 1, that is, a smartphone according to one preferred embodiment of the present disclosure. The mobile electronic device 1 includes a camera module la which is built into it. The camera module 1a comprises a variable aperture device (hereinafter, also referred to as “VA device”) 10 as detailed below.

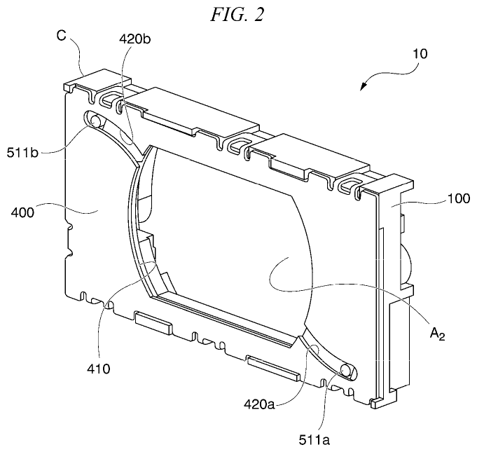

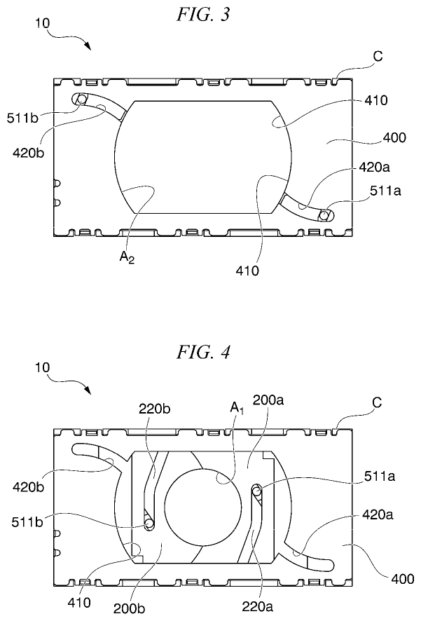

FIG. 2 shows a perspective view of the VA device 10 built into the camera module 1a shown in FIG. 1. FIG. 3 shows a front view of the same VA device 10. The VA device 10 is in an “open state” in FIGS. 2 and 3. That is, in the state shown in FIGS. 2 and 3, a fixed aperture A₂ (detailed later) is implemented in the VA device 10.

FIG. 4 also shows a front view of the VA device 10. However, contrary to FIGS. 2 and 3, the VA device 10 is in a “closed state” in FIG. 4. That is, in the state shown in FIG. 4, a central aperture A₁ (detailed later) is implemented in the VA device 10.

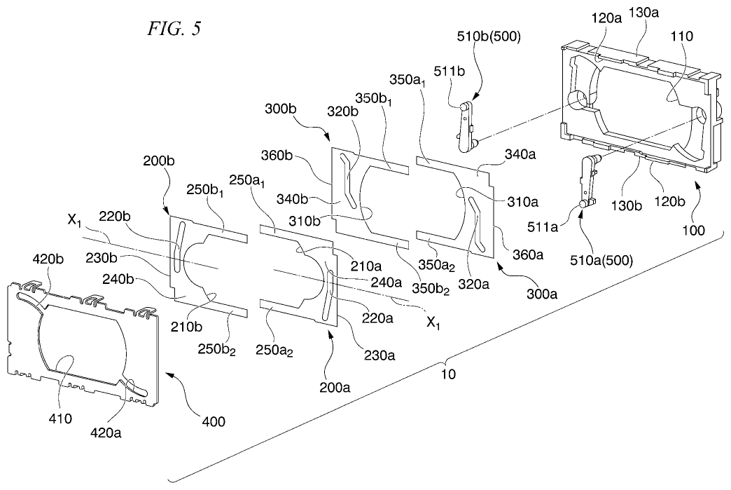

FIG. 5 shows an exploded perspective view of the VA device 10. As can be seen from FIG. 5, the VA device 10 mainly comprises: a base 100; a pair of main blades 200a, 200b; a pair of supplemental blades 300a, 300b; a cover 400; and an actuator 500. The base 100 and the cover 400 collaborate to form a rectangular casing C to store the pair of main blades 200a, 200b, the pair of supplemental blades 300a, 300b, and rotatable arms (detailed later) of the actuator 500. Although a main body (i.e., a drive unit) of the actuator 500 is not shown, this may be embodied by, for example, a micromotor or the like, especially an ultrasonic micromotor or an electromagnetic micromotor.

The base 100 has a base aperture 110 and a pair of blade guides (i.e., a pair of guide rails) 120a, 120b. The base aperture 110 substantially corresponds to the fixed aperture A₂ in terms of shape and size. The pair of blade guides 120a, 120b are provided on opposite longitudinal (horizontal) edges 130a, 130b of the base 100 with the base aperture 110 in between. The pair of blade guides 120a, 120b extend parallel to each other.

The pair of main blades 200a, 200b are guided by the pair of blade guides 120a, 120b of the base 100. That is, the pair of main blades 200a, 200b are slidably arranged relative to the base 100 so as to be close to and separated from each other. Furthermore, the pair of main blades 200a, 200b are always partially overlapped with each other. As can be seen from FIG. 5, each of the main blades 200a, 200b has an approximately U-shape as a whole. More specifically, each of the main blades 200a, 200b comprises a blade back (i.e., base portion) 240a, 240b and a pair of fingers 250a₁, 250a₂, 250b₁, 250b₂ extending from the opposite ends of the respective blade back 240a, 240b. As a result, each of the main blades 200a, 200b has respective notch 210a, 210b. Each of the notches 210a and 210b includes: a wide area involved in a formation of a fixed aperture A2; and a semi-circular area involved in a formation of the central aperture A1, which extends further from the wide area into respective blade back 240a, 240b. Therefore, these two notches 210a, 210b collaboratively define a central aperture A1 when the pair of main blades 200a, 200b are closest to each other. In this embodiment, the central aperture Al that is collaboratively defined by the notches 210a, 210b is circular. Furthermore, the notches 210a, 210b collaboratively define the fixed aperture A2 when the pair of main blades 200a, 200b are farthest from each other.

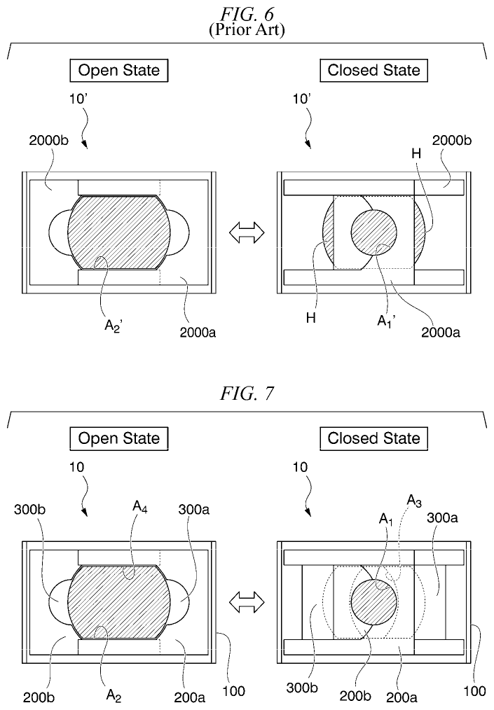

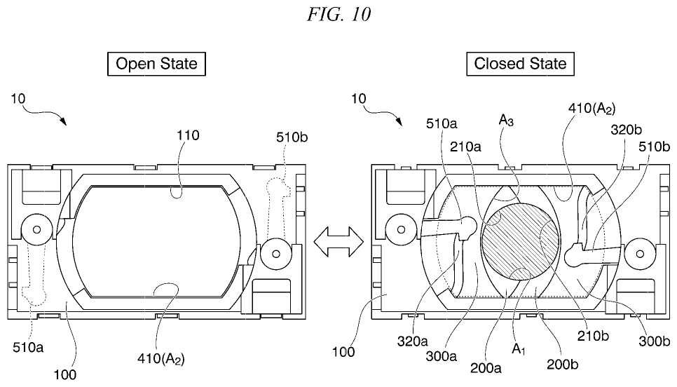

The pair of supplemental blades 300a, 300b are also guided by the pair of blade guides 120a, 120b of the base 100. That is, the pair of supplemental blades 300a, 300b are slidably arranged relative to the base 100 so as to be close to and separated from each other. Furthermore, the pair of supplemental blades 300a, 300b are always partially overlapped with each other. As can be seen from FIG. 5, each of the supplemental blades 300a, 300b also has an approximately U-shape as a whole. More specifically, each of the supplemental blades 300a, 300b comprises a blade back (i.e., base portion) 340a, 340b and a pair of fingers 350a1, 350a2, 350b1, 350b2 extending from the opposite ends of the respective blade back 340a, 340b. As a result, each of the supplemental blades 300a, 300b has respective notch 310a, 310b. These two notches 310a, 310b collaboratively define a minimum aperture A3 (see FIGS. 7 and 10) surrounding the central aperture A1 when the pair of supplemental blades 300a, 300b are closest to each other. Furthermore, the notches 310a, 310b collaboratively define a maximum aperture A4 (see FIG. 7) when the pair of supplemental blades 300a, 300b are farthest from each other. The maximum aperture A4 substantially corresponds to the fixed aperture A₂.

The cover 400 is fixed to the base 100, for example, by a snap fitting. The cover 400 has a cover aperture 410 substantially corresponding to the fixed aperture A₂. The cover 400 is configured to restrain the pair of main blades 200a, 200b and the pair of supplemental blades 300a, 300b in a thin space between the base 100 and the cover 400. In this embodiment, the pair of supplemental blades 300a, 300b are interposed between the base 100 and the pair of main blades 200a, 200b. However, in another embodiment, the pair of supplemental blades 300a, 300b may be interposed between the cover 400 and the pair of main blades 200a, 200b.

The actuator 500 is configured for moving (sliding) the pair of main blades 200a, 200b and the pair of supplemental blades 300a, 300b relative to the base 100. More specifically, as shown in FIG. 5, the actuator 500 includes a pair of rotatable arms 510a, 510b. A boss 511a, 511b is provided at the tip of the respective arms 510a, 510b. In this embodiment, the pair of rotatable arms 510a, 510b are rotatably supported by the base 100. However, in other embodiment, the pair of rotatable arms 510a, 510b may be rotatably supported by any member other than base 100 in the camera module 1a. The base ends of the rotatable arms 510a, 510b are mechanically connected to a drive unit (not shown) such as a micro-motor. By activating the drive unit, the rotatable arms 510a, 510b can be rotated clockwise or counterclockwise in FIG. 5. In this embodiment, the first arm 510a and the second arm 510b of the pair of rotatable arms are configured to rotate in an opposite direction to each other.

As can be also seen from FIG. 5, the pair of main blades 200a, 200b have respective cam grooves 220a, 220b. Similarly, the pair of supplemental blades 300a, 300b have respective cam groove 320a, 320b. Each of the cam grooves 220a, 220b, although not limited to this, consists of two linear sections connected with each other at an angle. Among these two linear sections, the one that intersects with a center axis X₁ of symmetry of the main blades 200a, 200b is placed parallel to lateral (vertical) edges 230a, 230b of the main blades 200a, 200b. Each of the cam grooves 320a, 320b, although not limited to this, consists of one intermediate straight section and two end sections connected with the intermediate straight section at an angle at both ends thereof. The intermediate section of the cam grooves 320a, 320b is arranged parallel to the lateral (vertical) edges 360a, 360b of the supplemental blades 300a, 300b. In addition to this, the two end sections of the cam grooves 320a, 320b are inclined in the same direction as each other.

The boss 511a, 511b of the rotatable arms 510a, 510b is configured to be accommodated both within the cam grooves 220a, 220b of the main blades 200a, 200b and the cam groove 320a, 320b of the supplemental blades 300a, 300b. As described in detail later, a rotation of the arm 510a, 510b is converted by the cam grooves 220a, 220b of the main blades 200a, 200b and the cam groove 320a, 320b of the supplemental blades 300a, 300b into a linear movement (i.e., a horizontally sliding movement in FIG. 5) of the main blades 200a, 200b and the supplemental blades 300a, 300b. In this embodiment, when the pair of main blades 200a, 200b and the pair of supplemental blades 300a, 300b move linearly, the first arm 510a and the second arm 510b of the pair of rotatable arms rotate in an opposite direction to each other.

In addition to the main blades 200a, 200b and the supplemental blades 300a, 300b, the cover 400 also has a pair of cam grooves 420a, 420b. These cam grooves 420a, 420b extend substantially diagonally from near the corner of the cover aperture 410 of the cover 400. In particular, in this embodiment, the cam grooves 420a, 420b extend along a part of an arc having a predetermined curvature. As can be seen from FIG. 3, while the VA device 10 is working, the boss 511a, 511b of the rotatable arms 510a, 510b is configured to be able to enter into the cam grooves 420a, 420b of the cover 400. On the other hand, the cam grooves 220a, 220b of the main blades 200a, 200b and the cam groove 320a, 320b of the supplemental blades 300a, 300b always accommodates (restrains) the boss 511a, 511b of the rotatable arms 510a, 510b.

As described in detail later, in this embodiment, when the pair of main blades 200a, 200b and the pair of supplemental blades 300a, 300b are closest to each other, each of the supplemental blades 300a, 300b projects outward from lateral (vertical) edges 230a, 230b of the main blades 200a, 200b. Here, the lateral edge means the edge that is perpendicular to the longitudinal or horizontal edges 130a, 130b of the base 100. Also in this embodiment, when the pair of supplemental blades 300a, 300b has moved to a closed position (in this position, the minimum aperture A₃ is collaboratively defined by the notches 310a, 310b of the pair of supplemental blades 300a, 300b), the cam grooves 320a, 320b of the supplemental blades 300a, 300b are covered by the pair of main blades 200a, 200b. Similarly, in this position, the cam grooves 220a, 220b of the main blades 200a, 200b are covered by the pair of supplemental blades 300a, 300b.

In this embodiment, when the pair of supplemental blades 300a, 300b has moved to the closed position, the pair of rotatable arms 510a, 510b are in a position approximately parallel to the direction of movement of the pair of supplemental blades 300a, 300b, that is, the longitudinal direction of the base 100. Furthermore, in this embodiment, when the pair of rotatable arms 510a, 510b are in a position approximately parallel to the direction of movement of the pair of supplemental blades 300a, 300b, the pair of rotatable arms 510a, 510b are hidden behind the pair of supplemental blades 300a, 300b.

As stated above, the VA device 10 can exhibit an open state and a closed state. In the open state, all of the pair of main blades 200a, 200b and the pair of supplemental blades 300a, 300b are located outside the cover aperture 410 of the cover 400, and thus outside the fixed aperture A₂, whose shape is also determined by the cover aperture 410 of the cover 400. When the VA device 10 is operated to exhibit the closed state, the main blades 200a and the supplemental blades 300a are driven into a predetermined position along the blade guide 120a, 120b of the base 100 by the rotation of the rotatable arm 510a, and the main blades 200b and the supplemental blades 300b are driven into a predetermined position along the blade guide 120a, 120b of the base 100 by the rotation of the rotatable arm 510b. On the other hand, when the VA device 10 is operated to exhibit the open state, the main blades 200a and the supplemental blades 300a are driven into a predetermined position along the blade guide 120a, 120b of the base 100 by the rotation of the rotatable arm 510a, and the main blades 200b and the supplemental blades 300b are driven into a predetermined position along the blade guide 120a, 120b of the base 100 by the rotation of the rotatable arm 510b. As described above, such a sliding linear movement of the pair of main blades 200a, 200b and the pair of supplemental blades 300a, 300b is caused by the interaction between the boss 511a, 511b of the rotatable arms 510a, 510b and the cam grooves 220a, 220b, 320a, 320b of the blades 200a, 200b, 300a, 300b.

The operations, functions and benefits of the above-stated VA device 10 will be described below with reference to FIGS. 6 to 12.

### Key Point 1

FIG. 6 schematically shows a fixed aperture and a central aperture formed in the conventional VA device 10′, and FIG. 7 schematically shows a fixed aperture and a central aperture formed in the VA device 10 as described above. In FIG. 6, the blades for forming a central aperture A₁′ and a fixed aperture A₂′ are indicated by the numerical references “2000a”, “2000b”, and in FIG. 7, the blades (i.e., the main blades) for forming a central aperture A₁ and a fixed aperture A₂ are indicated by the numerical references “200a”, “200b”. In general, in order to miniaturize the VA device, it is required to shorten the blade back of the blades for forming a central aperture in the sliding movement direction thereof (i.e., the horizontal direction in FIGS. 6 and 7). By shortening the blade back of these blades, the space to store the blades in the open state can be saved, and as a result, the VA device can miniaturized. However, in case of shortening the blade back of the blades 2000a, 2000b in a conventional structure, the VA device 10′ cannot work as intended. This is because unfavorable holes H appear in addition to a central aperture A₁′ in the closed state of the VA device 10′. This means that the blade back of the blades 2000a, 2000b must be large enough to prevent a phenomenon like this. Therefore, in the conventional VA device 10′, there is a limit to the miniaturization of the VA device. On the contrary, in the present embodiment, the pair of supplemental blades 300a, 300b are added to the VA device 10. Fundamentally, like a conventional structure, unfavorable holes are also inevitably created in addition to the central aperture A₁ in the closed state of the VA device 10 in which the main blades 200a, 200b are shortened. However, as can be seen from FIG. 7, the pair of supplemental blades 300a, 300b completely cover these unfavorable holes. Therefore, in the present embodiment, there is no problem caused by shortening the blades. For these reasons, in the present embodiment, the VA device 10 can be miniaturized compared to the conventional device.

### Key Point 2

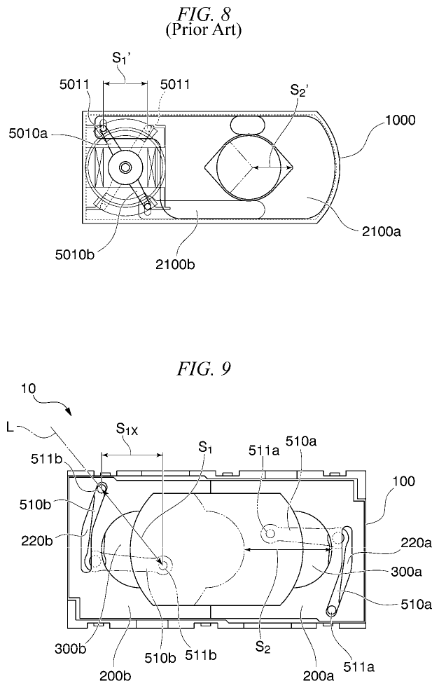

FIG. 8 schematically shows the relationship between the arm stroke and the blade stroke in the conventional VA device, and FIG. 9 schematically shows the relationship between the arm stroke and the blade stroke in the VA device 10 as described above. In the conventional structure, the arm 5010a, 5010b rotates on the base 1000 around the rotation axis and drives blade 2100a, 2100b. Therefore, the line connecting arm tip (i.e., boss) 5011 in the open state and the closed state is approximately parallel with the direction of the blade movement. This means that the arm stroke S₁′ from the open state to the closed state is approximately the same as the blade stroke S₂′ from the open state to the closed state. On the other hand, in the present embodiment, although the arms 510a, 510b also rotate on the base 100 around the rotation axis like in the conventional structure, the straight line L connecting the arm tips (i.e., boss 511a, 511b) in the open state and the closed state has an angle with respect to the direction of the blade movement, for example about 45 degrees, as shown in FIG. 9. In addition to this, in the present embodiment, the rotational movement of the arms 510a, 510b is converted into the linear movement of the blades 200a, 200b, 300a, 300b by the cam grooves 220a, 220b, 320a, 320b formed thereon. By adapting such a structure, in the present embodiment, the width (horizontal) component S_{1X} of the arm stroke S₁ from the open state to the closed state can be shorter than the blade stroke S₂ from the open state to the closed state. Therefore, in the present embodiment, the width size of the VA device can be reduced compared to the conventional structure.

### Key Point 3

FIG. 10 schematically shows the AV device 10 according to the present embodiment in the open state and the closed state, seen from the back (i.e., from a lens side of the camera module). In the open state, the aperture shape is determined by the cover aperture 410 (which substantially corresponds to the fixed aperture A₂) of the cover 400. In this state, all of the blades 200a, 200b, 300a, 300b and the arms 510a, 510b locate outside of the fixed aperture A₂. On the other hand, in the closed state, the blades 200a, 200b, 300a, 300b are driven to inside the fixed aperture A₂. In this state, the central aperture A₁ defined by the inner diameter of the notch 210a, 210b of the main blades 200a, 200b determines an aperture shape in the closed state. Furthermore, in this state, the arms 510a, 510b are also located inside of the fixed aperture A₂. In the present embodiment, by adopting the unique structure in which a portion of the actuator 500, i.e., the arms 510a, 510b that drive the blades 200a, 200b, 300a, 300b enter inside the fixed aperture A₂ in the closed state, the arms 510a, 510b can be located nearer to the center of the device 10. As a result, the VA device size can be further miniaturized. In addition to this, since a portion of the arms 510a, 510b which enters inside the fixed aperture A₂ in the closed state is covered with the blades 200a, 200b, 300a, 300b, the arms 510a, 510b do not affect any optical performance and other functions of the VA device. Moreover, the arms 510a, 510b do not damage the appearance (an appearance quality) of the VA device. This is because the arm 510a, 510b cannot be recognized from the front side since they are covered by the blades 200a, 200b, 300a, 300b.

### Key Point 4

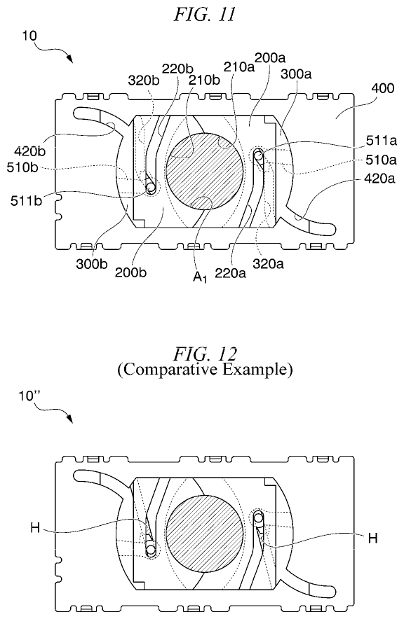

FIG. 11 schematically shows the relationship between each blade position in the closed state in the present embodiment, seen from the front side, and FIG. 12 schematically shows the relationship between each blade position in the closed state in a comparative example where the shape of the cam groove is not appropriate, seen from the front side. For the purpose of clarity, the main blades 200a, 200b are made translucent. As described above, the central aperture A1 defined by the inner diameter of the notch 210a, 210b of the main blades 200a, 200b determines a aperture shape in the closed state. Each of the blades have respective cam groove thereon, and the boss provided on the arm tip fits into respective cam groove. In the present embodiment, in the closed state, the cam groove 220a of the main blade 200a is covered by the supplemental blade 300a located behind the main blade 200a. On the other hand, the cam groove 320a of the supplemental blade 300a is covered by the main blade 200a located in front of the supplemental blade 300a. Similarly, the cam groove 220b of the main blade 200b is covered by the supplemental blade 300b located behind the main blade 200b. On the other hand, the cam groove 320b of the supplemental blade 300b is covered by the main blade 200b located in front of the supplemental blade 300b. As such, in the present embodiment, the shape and the location of the cam groove 220a, 220b, 320a, 320b of each blade is arranged such that one certain groove is securely covered by the other blades. Therefore, in the present embodiment, unfavorable holes are prevented from appearing around the central aperture A₁ in the closed state. On the other hand, if the shape and/or the location of the cam grooves are not appropriate, in other words, if the cam grooves are not covered by any blades, as shown in FIG. 12, the VA device 10″ cannot work well due to the occurrence of the unfavorable hole H in the closed state.

As can be understood from the above explanation, a larger aperture size and shape in the open state is a great contribution realized by the present disclosure with regard to the miniaturization of the VA device. Therefore, the VA device according to the present disclosure is especially suitable for a lens with large aperture (bright Fno.). In addition, the basic structure of the above stated embodiment in which the arm rotates by the actuator and the arm drives each blade linearly, is the same as that of conventional devices, so that a reliability of the VA device according to the preferred embodiment of the present disclosure is at the same level as the conventional devices. Therefore, a small VA device with a sufficient reliability can be realized. Again, the VA device according to the preferred embodiment of the present disclosure brings the benefits described above by having the following characteristics:
1. A blade back of the main blades which determine an aperture shape in the closed state is shortened, and at the same time, additional blades are arranged in order to cover a gap (hole) between the fixed aperture (i.e., an aperture in the open state) and the main blades;
2. A straight line that connects the boss of the arm tip in the open state and in the closed state makes an angle with respect to the direction of the sliding movement of the blades;
3. A portion of the actuator, for example the arm, enters inside the fixed aperture (i.e., an aperture in the open state) in the closed state; and
4. A shape and location of the cam groove of some blades is arranged to be covered with the other blades in the closed state.

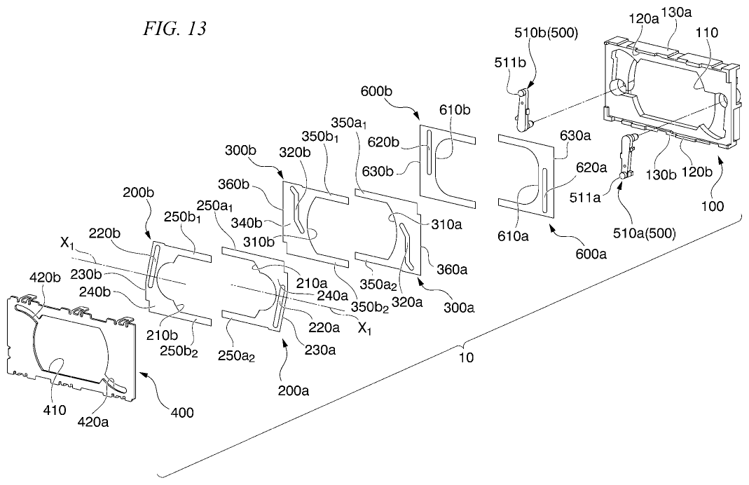

In the following, an alternative embodiment of the present disclosure will be described in detail using FIGS. 13 to 15. In FIGS. 13 to 15, the same or substantially the same components as the components in the embodiments described above are indicated by the same reference numerals and the descriptions thereof are omitted. FIG. 13 shows an exploded perspective view of the VA device 10 according to the alternative embodiment of the preset invention. As can be seen from FIG. 13, the VA device 10 also comprises: a base 100; a pair of main blades 200a, 200b; a pair of supplemental blades 300a, 300b; a cover 400; and an actuator 500 including rotatable arms 510a, 510b.

In addition to these components, this alternative VA device 10 further comprises a pair of secondary supplemental blades 600a, 600b. These secondary supplemental blades 600a, 600b are also guided by the pair of blade guides 120a, 120b of the base 100. That is, the pair of secondary supplemental blades 600a, 600b are slidably arranged relative to the base 100 so as to be close to and separated from each other. Furthermore, the pair of second supplemental blades 600a, 600b are always partially overlapped with each other. In this embodiment, the pair of secondary supplemental blades 600a, 600b are interposed between the base 100 and the pair of supplemental blades 300a, 300b. However, in another embodiment, the pair of secondary supplemental blades 600a, 600b may be interposed between the pair of supplemental blades 300a, 300b and the pair of main blades 200a, 200b or between the pair of main blades 200a, 200b and the cover 400.

Each of the secondary supplemental blades 600a, 600b has a respective notch 610a, 610b in the shape of a U-shape. The notches 610a, 610b collaboratively define a minimum aperture A₅ surrounding the central aperture A₁ when the pair of secondary supplemental blades 600a, 600b are closest to each other (see FIG. 15). These two notches 610a, 610b also collaboratively define a maximum aperture A₆ substantially corresponding to (or surrounding in another embodiment) the fixed aperture A₂ when the pair of secondary supplemental blades 600a, 600b are farthest from each other (see FIG. 15).

As can be seen from FIG. 13, the pair of secondary supplemental blades 600a, 600b, in this embodiment, have respective cam grooves 620a, 620b in the straight form. Each of the cam grooves 620a, 620b is arranged parallel to the lateral (vertical) edges 630a, 630b of the secondary supplemental blades 600a, 600b. The boss 511a, 511b of the rotatable arms 510a, 510b is configured to be further accommodated within the cam grooves 620a, 620b of the secondary supplemental blades 600a, 600b. The rotation of the arms 510a, 510b is converted by the cam grooves 620a, 620b of the secondary supplemental blades 600a, 600b into a linear movement thereof. That is, the pair of secondary supplemental blades 600a, 600b is driven together with the pair of main blades 200a, 200b and the pair of supplemental blades 300a, 300b by the rotatable arms 510a, 510b.

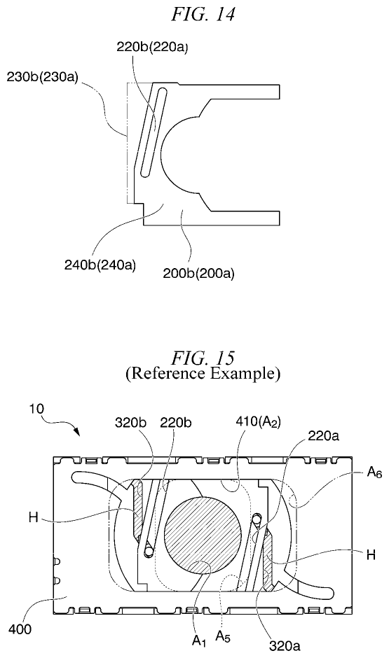

As can be seen from FIG. 14, the pair of main blades 200a, 200b in this alternative embodiment is modified from the pair of main blades in the previously described embodiment. More specifically, in this alternative embodiment, a part of the lateral (vertical) edge 230a, 230b of previously described main blades 200a, 200b is cut diagonally. As a result, the longitudinal (horizontal) upper length of each main blades 200a, 200b is smaller than the longitudinal lower length thereof. Furthermore, the cam grooves 220a and 220b of the main blades 200a, 200b have been modified into a linear form.

In this embodiment, each of the secondary supplemental blades 600a, 600b is configured to project outward from lateral edges 230a, 230b of the main blades 200a, 200b when the pair of main blades 200a, 200b, the pair of supplemental blades 300a, 300b, and the pair of secondary supplemental blades 600a, 600b are closest to each other, respectively. As a result of having such a characteristic configuration, this alternative embodiment exerts the following effects.

In this alternative embodiment, in order to save more space to store the various blade in the open state, the blade back 240a, 240b of the main blade 200a, 200b is shortened compared to the first embodiment (see FIG. 14). The outline of the blade back in the first embodiment is shown by a virtual line. However, simply shortening the blade back 240a, 240b of the main blade 200a, 200b will result in that part of cam groove 320a, 320b of the supplemental blade 300a, 300b being unable to be covered with the main blade 200a, 200b. That is, an undesired hole H is created outside the central aperture A₁ that allows light to pass through (see the shaded area in FIG. 15). In this state, the VA device 10 cannot perform the intended function. In this alternative embodiment, in order to overcome such an ancillary shortcoming, the pair of secondary supplemental blades 600a, 600b are added to cover the undesired hole H. By adapting this structure, the space to store the various blade can be saved compared to the first embodiment, and thus the VA device 10 can be made even more compact.

Preferred embodiments of the present disclosure have been explained above with reference to the related drawings. However, the present disclosure is not limited to these embodiments, and various modifications and changes may be made to the above-described embodiments without deviating from the gist and scope of the present disclosure, and such modifications and changes are also included in the scope of the present disclosure.

1. A variable aperture device for a camera module comprising:
a base having a base aperture and a pair of blade guides, wherein the pair of blade guides are provided on opposite longitudinal edges of the base with the base aperture in between;
a pair of main blades guided by the pair of blade guides of the base, wherein the pair of main blades are slidably arranged relative to the base so as to be close to and separated from each other, wherein each of the main blades has a respective notch, and wherein the notches collaboratively define a central aperture (A₁) when the pair of main blades are closest to each other, and collaboratively define a fixed aperture (A₂) when the pair of main blades are farthest from each other;
a pair of supplemental blades guided by the pair of blade guides of the base, wherein the pair of supplemental blades are slidably arranged relative to the base so as to be close to and separated from each other, wherein each of the supplemental blades has a respective supplemental notch, and wherein the supplemental notches collaboratively define a minimum aperture (A₃) surrounding the central aperture (A₁) when the pair of supplemental blades are closest to each other, and collaboratively define a maximum aperture (A₄) substantially corresponding to the fixed aperture (A₂) when the pair of supplemental blades are farthest from each other;
a cover that is fixed to the base and has a cover aperture substantially corresponding to the fixed aperture (A₂), wherein the cover is configured to restrain the pair of main blades and the pair of supplemental blades in a space between the base and the cover; and
an actuator for moving the pair of main blades and the pair of supplemental blades relative to the base,
wherein each of the supplemental blades is configured to project outward from lateral edges of the main blades perpendicular to the longitudinal edges of the base when the pair of main blades are closest to each other and the pair of supplemental blades are closest to each other.

2. The variable aperture device according to claim 1, wherein the pair of supplemental blades are interposed between the base and the pair of the main blades.

3. The variable aperture device according to claim 1, wherein the actuator includes a pair of rotatable arms with a boss provided at the tip of the rotatable arms, wherein the pair of main blades have respective cam grooves, and the pair of supplemental blades have respective cam grooves, wherein the boss of the rotatable arms is configured to be accommodated within the cam grooves of the main blades and the cam grooves of the supplemental blades, and wherein a rotation of the rotatable arms is converted by the cam grooves of the main blades and the cam grooves of the supplemental blades into a linear movement of the main blades and the supplemental blades.

4. The variable aperture device according to claim 3, wherein the pair of rotatable arms are rotatably supported by the base.

5. The variable aperture device according to claim 3, wherein the cover has a pair of cam grooves, and wherein the boss of the rotatable arms is configured to enter into the cam grooves of the cover.

6. The variable aperture device according to claim 3, wherein when the pair of supplemental blades has moved to a closed position where the minimum aperture (A₃) is collaboratively defined by the supplemental notches of the pair of supplemental blades, the cam grooves of the supplemental blades are covered by the pair of main blades, and the cam grooves of the main blades are covered by the pair of supplemental blades.

7. The variable aperture device according to claim 1, wherein when the pair of supplemental blades has moved to a closed position where the minimum aperture (A₃) is collaboratively defined by the supplemental notches, the pair of rotatable arms are in a position approximately parallel to the direction of movement of the pair of supplemental blades.

8. The variable aperture device according to claim 7, wherein when the pair of rotatable arms are in a position approximately parallel to the direction of movement of the pair of supplemental blades the pair of rotatable arms are hidden behind the pair of supplemental blades.

9. The variable aperture device according to claim 1, wherein when the pair of main blades and the pair of supplemental blades move linearly, the first arm and the second arm of the pair of rotatable arms rotate in an opposite direction to each other.

10. The variable aperture device according to claim 1, wherein the variable aperture device further comprises a pair of secondary supplemental blades guided by the pair of blade guides of the base, wherein the pair of secondary supplemental blades are slidably arranged relative to the base so as to be close to and separated from each other, wherein each of the secondary supplemental blades has a respective secondary supplemental notch, wherein the secondary supplemental notches collaboratively define a minimum aperture (A₅) surrounding the central aperture (A₁) when the pair of secondary supplemental blades are closest to each other, and collaboratively define a maximum aperture (A₆) surrounding or substantially corresponding to the fixed aperture (A₂) when the pair of secondary supplemental blades are farthest from each other, and wherein each of the secondary supplemental blades is configured to project outward from the lateral edges of the main blades perpendicular to the longitudinal edges of the base when the pair of main blades are closest to each other, the pair of supplemental blades are closest to each other, and the pair of secondary supplemental blades are closest to each other.

11. The variable aperture device according to claim 10, wherein the pair of secondary supplemental blades have respective cam grooves, wherein the boss of the rotatable arms is configured to be further accommodated within the cam grooves of the secondary supplemental blades, and wherein the rotation of the rotatable arms is converted by the cam grooves of the secondary supplemental blades into a linear movement of the secondary supplemental blades.

12. The variable aperture device according to claim 10, wherein the pair of secondary supplemental blades are interposed between the base and the pair of supplemental blades.

13. The variable aperture device according to claim 1, wherein the central aperture (A₁) that is collaboratively defined by the notches of the pair of main blades is circular.

14-16. (canceled)

17. An electronic device, wherein the electronic device comprises a camera module, wherein the camera module comprises a variable aperture device, the variable aperture device comprising:
a base having a base aperture and a pair of blade guides, wherein the pair of blade guides are provided on opposite longitudinal edges of the base with the base aperture in between;
a pair of main blades guided by the pair of blade guides of the base, wherein the pair of main blades are slidably arranged relative to the base so as to be close to and separated from each other, wherein each of the main blades has a respective notch, and wherein the notches collaboratively define a central aperture (A₁) when the pair of main blades are closest to each other, and collaboratively define a fixed aperture (A₂) when the pair of main blades are farthest from each other;
a pair of supplemental blades guided by the pair of blade guides of the base, wherein the pair of supplemental blades are slidably arranged relative to the base so as to be close to and separated from each other, wherein each of the supplemental blades has a respective supplemental notch, and wherein the supplemental notches collaboratively define a minimum aperture (A₃) surrounding the central aperture (A₁) when the pair of supplemental blades are closest to each other, and collaboratively define a maximum aperture (A₄) substantially corresponding to the fixed aperture (A₂) when the pair of supplemental blades are farthest from each other;
a cover that is fixed to the base and has a cover aperture substantially corresponding to the fixed aperture (A₂), wherein the cover is configured to restrain the pair of main blades and the pair of supplemental blades in a space between the base and the cover; and
an actuator for moving the pair of main blades and the pair of supplemental blades relative to the base,
wherein each of the supplemental blades is configured to project outward from lateral edges of the main blades perpendicular to the longitudinal edges of the base when the pair of main blades are closest to each other and the pair of supplemental blades are closest to each other

18. A variable aperture device for a camera module comprising:
a base having a base aperture and a pair of blade guides, wherein the pair of blade guides are provided on opposite longitudinal edges of the base with the base aperture in between;
a pair of main blades guided by the pair of blade guides of the base wherein the pair of main blades are slidably arranged relative to the base so as to be close to and separated from each other, wherein each of the main blades has a respective notch, and wherein the notches collaboratively define a central aperture (A₁) when the pair of main blades are closest to each other;
a pair of supplemental blades guided by the pair of blade guides of the base, wherein the pair of supplemental blades are slidably arranged relative to the base so as to be close to and separated from each other, wherein each of the supplemental blades has a respective supplemental notch, and wherein the supplemental notches collaboratively define a maximum aperture (A₄) when the pair of supplemental blades are farthest from each other;
a cover that is fixed to the base and has a cover aperture substantially corresponding to the fixed aperture (A₂), wherein the cover is configured to restrain the pair of main blades and the pair of supplemental blades in a space between the base and the cover; and
an actuator for moving the pair of main blades and the pair of supplemental blades relative to the base;
wherein the actuator includes a pair of rotatable arms with a boss provided at the tip of the rotatable arms, wherein the pair of main blades have respective cam grooves, and the pair of supplemental blades have respective cam grooves, wherein the boss of the rotatable arms is configured to be accommodated within the cam grooves of the main blades and the cam grooves of the supplemental blades, and wherein a rotation of the rotatable arms is converted by the cam grooves of the main blades and the cam grooves of the supplemental blades into a linear movement of the main blades and the supplemental blades;
wherein when the pair of supplemental blades has moved to a closed position where the minimum aperture (A₃) is collaboratively defined by the notches of the pair of supplemental blades, the cam grooves of the supplemental blades are covered by the pair of main blades, and the cam grooves of the main blades are covered by the pair of supplemental blades.

19. The variable aperture device according to claim 18, wherein the pair of rotatable arms are rotatably supported by the base.

20. The variable aperture device according to claim 18, wherein the cover has a pair of cam grooves, and wherein the boss of the rotatable arms is configured to enter into the cam grooves of the cover.

21. The variable aperture device according to claim 18, wherein when the pair of supplemental blades has moved to a closed position where the minimum aperture (A₃) is collaboratively defined by the supplemental notches of the pair of supplemental blades, the pair of rotatable arms are in a position approximately parallel to the direction of movement of the pair of supplemental blades.

22. The variable aperture device according to claim 18, wherein when the pair of rotatable arms are in a position approximately parallel to the direction of movement of the pair of supplemental blades the pair of rotatable arms are hidden behind the pair of supplemental blades.

23. The variable aperture device according to claim 18, wherein when the pair of main blades and the pair of supplemental blades move linearly, the first arm and the second arm of the pair of rotatable arms rotate in an opposite direction to each other.
